(19) United States
(12) Patent Application Publication
(10) Pub. No.: US 2009/0252505 A1
(43) Pub. Date: Oct. 8, 2009

(54) PHASE-MODULATED SIGNAL RECEIVING DEVICE

(75) Inventors: Koji TERADA, Kawasaki (JP); Takashi SHIMIZU, Kawasaki (JP); Satoshi IDE, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/347,325

(22) Filed: Dec. 31, 2008

(30) Foreign Application Priority Data
Apr. 4, 2008 (JP) 2008-098182

(51) Int. Cl. H04B 10/06

(52) U.S. Cl. 398/208

(57) ABSTRACT

A monitor circuit detects the average light receiving current of a photoelectric conversion device for receiving a positive-phase intensity-modulated signal and outputs the detected current value to a control unit. The control unit adjusts the heater current of a phase adjustment heater in such a way as to maximize or minimize the output of the monitor circuit and controls the amount of delay of the phase reference light of a demodulator.

### FIELD

The present invention relates to a receiving device for receiving optical signals whose phases are modulated.

### BACKGROUND

In a next generation network (NGN), various services are operated with connection of various terminals for such as home information systems. The further extension of network transmitting capacity is required in the realization of the NGN to transmit large scale of data for the services. Since the transmitting capacity in the conventional NRZ modulation method is close to its limit from the viewpoint of the utilization efficiency of light frequencies. New modulation method, such as phase modulation, is studied in the extension of the transmitting capacity from 10 G bps to 40 G bps.

To receive a phase-modulated signal, its phase is detected by interference between a phase reference light and a transmitted optical signal, and converting it to an intensity-modulated signal according to their phase difference.

In various phase modulation methods, differential phase shift keying (DPSK) is a highly feasible phase modulation method since the configuration of the interfero-meter of the receiving device is simple, the precise control of the wavelength is not required because the phase of the previous-bit signal itself is used as the phase reference.

The effective optical path length difference between two-branched optical paths of a demodulator is determined by multiplying an effective refractive index by a physical optical path length difference and is needed to control in such a way as to an integral multiple of a wavelength around the delay of one bit (approximately 7.5 mm in the case of 40 Gbps). As to a monitor method for this control, various methods are proposed.

Patent document 1 describes that signal light from the two output ports of a Mach-Zehnder interferometer is photo-electrically converted, the difference of the converted electric signals is outputted from a balance type detection circuit and a second low frequency signal is detected from a signal outputted from the balance type detection circuit. Then, it is described that the second low frequency signal is synchronously detected by a first low frequency signal, the amount of deviation between the center frequency of a phase-modulated signal and the pass-band frequency of the Mach-Zehnder interferometer and its direction are detected by a synchronous detection circuit and the phase difference of the two-branched signals is adjusted in such a way as to correct the amount of deviation.

Patent document 2 describes that the interference signal of an optical delay interferometer is divided into its RF component and DC component, an extinction ratio is calculated by normalizing its RF power by its DC power and its relative delay is adjusted on the basis of the extinction ratio.

For a small-size transponder which accommodates a transmitting/receiving unit within its case, the miniaturization of a demodulator, which is not required in the conventional NRZ modulation method, and its auxiliary control circuit are needed.

If an optical signal is branched by a common 10:1 coupler for branching/monitoring an optical signal, the loss is approximately 0.5 dB for the main signal system, and the loss of a wave-guiding medium added in order to constitute the coupler should be added to it.

Then, when branching/monitoring an optical signal, a loss according to its branch ratio and the loss of a propagation medium forming the branch occur in the main signal system. In the same way, the loss occurs when branching an electric signal.

In the method of Patent document 2, since an impedance-mismatched photoelectric conversion device is connected to a 50-ohm transmission path leading from a bias T module to a trans-impedance amplifier, there is a high possibility that the reflection of the RF component may be superimposed on a non-reflective RF component and a distortion may occur in a signal waveform when passing a 40 Gbps high-speed signal through it. Since the degree of distortion depends on a connection distance between the photoelectric conversion device and the trans-impedance amplifier, the influence of the waveform distortion generally decreases if it is connected in a sufficiently shorter distance ( 1/10 of a wavelength) than the electric signal wavelength. In the case of 40 G DPSK, since a propagation distance corresponding to one bit of an electric signal is equal to or less than 8 mm, in order to suppress the waveform distortion, the photoelectric conversion device and the trans-impedance amplifier must be connected within 0.8 mm. In order to realize this, since the photoelectric conversion device must be directly connected to the trans-impedance amplifier, it is difficult to insert the bias T module.

Furthermore, there is a common problem to the technologies of Patent documents 1 and 2 that the size of a receiving unit increases. In the invention of Patent document 1, an optical branch circuit and a photoelectric conversion device for monitor are required, and in the invention of Patent document 2, a bias T module is required. Since in order to insert these, space of cm order is required, it is difficult to realize a small-size receiving device.

Patent document 1: International Patent Laid-open No. 2005/088876

Patent document 2: Japan Patent Laid-open No. 2005-80304

### SUMMARY

The disclosed phase-modulated signal receiving device comprises an interferometer for making a phase-modulated optical signal interfere with a phase reference light obtained by delaying the phase-modulated optical signal and outputting an intensity-modulated optical signal according to its phase difference with the optical signal, a photoelectric conversion device for converting the intensity-modulated optical signal outputted from the interferometer to an electric signal, a monitor means for detecting the DC component or a sufficiently lower frequency component than a phase modulated frequency of current flowing through the photoelectric conversion device and a control means for controlling the amount of delay of the phase reference light of the interferometer in such a way as to maximize or minimize average current detected by the monitor means.

### BRIEF DESCRIPTION OF THE DRAWINGS

FIG. 1 shows a DPSK transmission system.

FIG. 2 shows the configuration of a demodulator and a phase adjustment circuit.

FIG. 3 shows the calculation result of the average current of photoelectric conversion devices in relation to the phase error of the demodulator.

FIG. 4 shows a relationship between the delay time and the average current deviation of the demodulator with some phase error.

FIG. 5 shows the phase adjustment circuit in the first preferred embodiment.

FIG. 6 shows the phase adjustment circuit in the second preferred embodiment.

FIG. 7 shows the phase adjustment circuit in the third preferred embodiment.

FIG. 8 shows the phase adjustment circuit in the fourth preferred embodiment.

FIG. 9 is a flowchart showing the processing operation in the case where positive-phase average light receiving current is monitored.

FIG. 10 is a flowchart showing the processing operation in the case where negative-phase average light receiving current is monitored.

### DESCRIPTION OF EMBODIMENTS

The preferred embodiments of the present invention are described below.

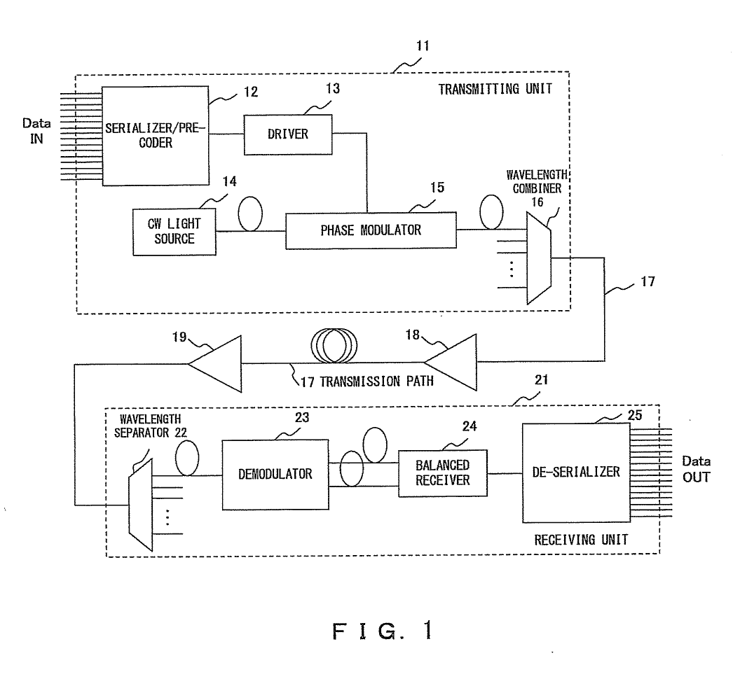

FIG. 1 shows the configuration of a DPSK (differential phase shift keying) transmission system in the preferred embodiment.

A transmitting unit 11 comprises a serializer/pre-coder 12, a driver 13, a continuous wave (CW) light source 14, a phase modulator 15 and a wavelength combiner 16.

The serializer/pre-coder 12 converts parallel data to serial data and outputs it to the driver 13. The driver 13 outputs the serial data to the phase modulator 15. The phase modulator 15 applies DPSK modulation to the phase of an optical signal outputted from the light source 14 on the basis of the serial data and outputs the modulated optical signal to the wavelength combiner 16.

The wavelength combiner 16 combines optical signals of a plurality of wavelengths and transmits them to an optical transmission path 17. On the optical transmission path 17 amplifiers 18 and 19 for amplifying optical signals are disposed.

A receiving unit 21 comprises a wavelength separator 22, a demodulator 23, a balanced receiver 24 and a de-serializer 25.

The wavelength separator 22 separates wavelength-multiplexed DPSK optical signals for each wavelength. The demodulator 23 makes the DPSK optical signal interfere with a signal obtained by delaying the DPSK optical signal by approximately one bit (or one symbol) of a transmission rate. Then, if the phase of the DPSK optical signal is the same as that of the previous bit of optical signal, the interfered optical signal is outputted to an output port on the positive phase side. If the phases of both optical signals are inverted each other, the interfered optical signal is outputted to an output port on the negative phase side.

The balanced receiver 24 comprises, for example, two photoelectric conversion devices connected in series and an amplifier which amplifies electric signals converted by the two photoelectric conversion devices. The de-serializer 25 converts the output signals of the balanced receiver 24 to parallel data.

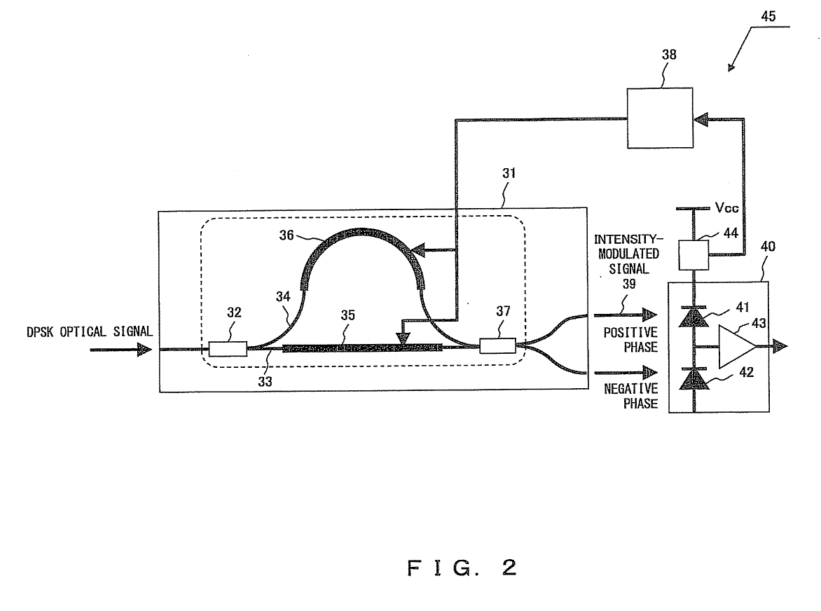

FIG. 2 shows the configuration of a demodulator 31 and a phase adjustment circuit 45. In FIG. 2, for the demodulator 31 (corresponding to the demodulator 23 shown in FIG. 1), a Mach-Zehnder type delay interferometer is used.

The demodulator 31 comprises an optical coupler 32, two optical waveguides 33 and 34, phase adjustment heaters 35 and 36, and an optical coupler 37.

An inputted DPSK optical signal is branched into two optical signals by the optical coupler 32. Then, one optical signal is transmitted to the optical waveguide 33 and the other optical signal is transmitted to the optical waveguide 34 having a longer optical path length than the optical waveguide 33. The phase adjustment heater 35 adjusts the refractive index of the optical waveguide 33 and the phase adjustment heater 36 adjusts the refractive index of the optical waveguide 34. Current flowing through these phase adjustment heaters 35 and 36 is controlled by a control unit 38 in such a way that the effective optical path length difference (effective refractive index*physical waveguide length difference) between the optical waveguide 33 and 34 may become the desired amount of delay.

The demodulator 31 comprises two complementary output ports. The optical coupler 37 outputs the interfered optical signal to the positive-phase side output port as an intensity-modulated signal 39 when the phase of the DPSK optical signal inputted from the optical waveguide 33 is the same as that of the previous DPSK optical signal inputted from the optical waveguide 34. When the phase of the DPSK optical signal inputted from the optical waveguide 33 is the reversal to the phase of the previous DPSK optical signal inputted from waveguide 34, the optical coupler 37 outputs the interfered optical signal to the negative-phase side output port as an intensity-modulated signal 39.

The phase adjustment circuit 45 comprises a control unit 38, a balanced receiver 40 and a monitor circuit 44.

The balanced receiver 40 comprises two photoelectric conversion devices 41 and 42 connected in series, and an amplifier 43. To the photoelectric conversion device 41 bias current is supplied from a bias power supply Vcc via the monitor circuit 44. The photoelectric conversion device 41 converts the positive-phase intensity-modulated signal 39 outputted from the positive-phase side output port to an electric signal.

The cathode of the photoelectric conversion device 42 is connected to the anode of the photoelectric conversion device 41 and the input terminal of the amplifier 43. Its anode may be grounded. The photoelectric conversion device 42 converts the negative-phase intensity-modulated signal 39 outputted from the negative-phase side output port to an electric signal.

The monitor circuit 44 monitors average current (average light receiving current) supplied to the photoelectric conversion devices 41 from the power supply Vcc (constant potential unit). The average current value detected by the monitor circuit 44 is outputted to the control unit 38. The monitor circuit 44 can be realized, for example, by a resistor, a circuit for detecting the voltage at each end of the resistor or a current detection circuit, a current transformer and the like.

In the FIG. 2 configuration where the average light receiving current flowing through the photoelectric conversion device 41, the control unit 38 controls current flowing through the phase adjustment heaters 35 and 36 in such a way as to maximize the average current of the photoelectric conversion devices 41 and 42, which is detected by the monitor circuit 44.

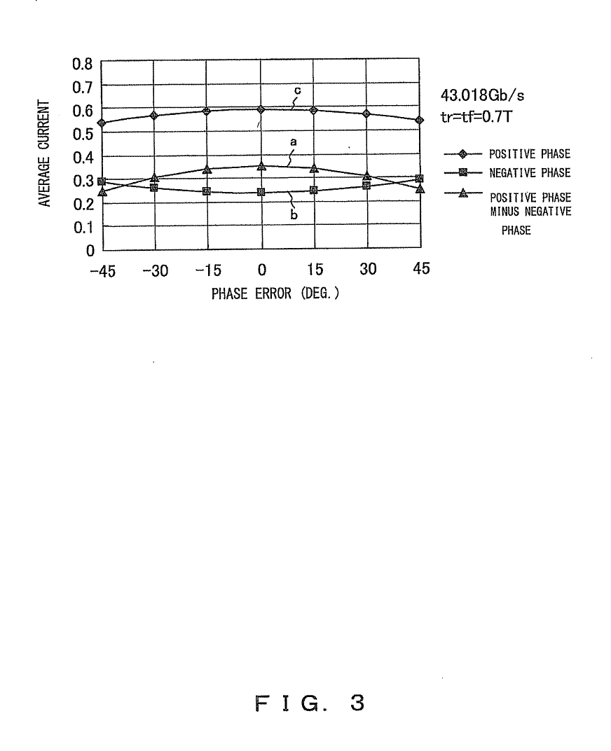

FIG. 3 shows the calculation result of the average current of photoelectric conversion devices in relation to the phase error of the demodulator 31.

We have found that there is a certain relationship between the phase error of a phase-modulated signal (DPSK-modulated optical signal) inputted to the demodulator 31 and the average light receiving current of the photoelectric conversion device 41 (or 42).

In FIG. 3 the information transmission rate is 43.018 Gb/s. The vertical axis of FIG. 3 indicates a relative value obtained by dividing the average light receiving current of the photoelectric conversion device 41 (or 42) by the maximum amplitude value of light receiving current in the case where the amount of delay of the demodulator 31 is one bit and its horizontal axis indicates a phase error (deg.).

In FIG. 3, a line-a connecting points shown by triangles indicates the relative value of the difference between positive-phase average light receiving current and negative-phase average light receiving current (hereinafter called average light receiving current difference) and a line-b connecting points shown by rectangles indicates the relative value of the negative-phase average light receiving current (hereinafter called negative-phase average light receiving current). A line-c connecting points shown by rhombuses indicates the relative value of the positive-phase average light receiving current (hereinafter called positive-phase average light receiving current).

As clear from FIG. 3, positive-phase average light receiving current becomes a local maximum (a maximum in a certain section) when the phase error is a minimum (0 deg.). Negative-phase average light receiving current becomes a local minimum (a minimum in a certain section) when the phase error is a minimum. The difference between positive-phase average light receiving current and negative-phase average light receiving current becomes a maximum when the phase error is a minimum.

It is for the following reasons that when average current flowing through a photoelectric conversion device is a local maximum (hereinafter called a maximum) or a local minimum (hereinafter called a minimum), the phase error becomes a minimum.

In the case of positive phase, as the phase error increases, the waveform in its transition area of current flowing through the photoelectric conversion device 41 approaches a 0 level. Therefore, the average value of the entire waveform including the amplitude of the transition area decreases. As a result, positive-phase average current flowing through the photoelectric conversion device 41 becomes a maximum when the phase error is a minimum.

In the case of negative phase, since its output and the negative phase output have a complementary relationship between them, as the phase error increases, the average value of waveforms in the transition area of current flowing through the photoelectric conversion device 42 increases. As a result, in the negative phase the average current of the photoelectric conversion device 42 becomes a minimum when the phase error is a minimum.

Therefore, if average current flowing through the photoelectric conversion device 41 or 42 which receives a positive-phase or negative-phase phase-modulated optical signal is monitored and the amount of delay of the demodulator 31 is controlled in such a way as to maximize or minimize the average current, the phase error of a phase-modulated optical signal can be reduced.

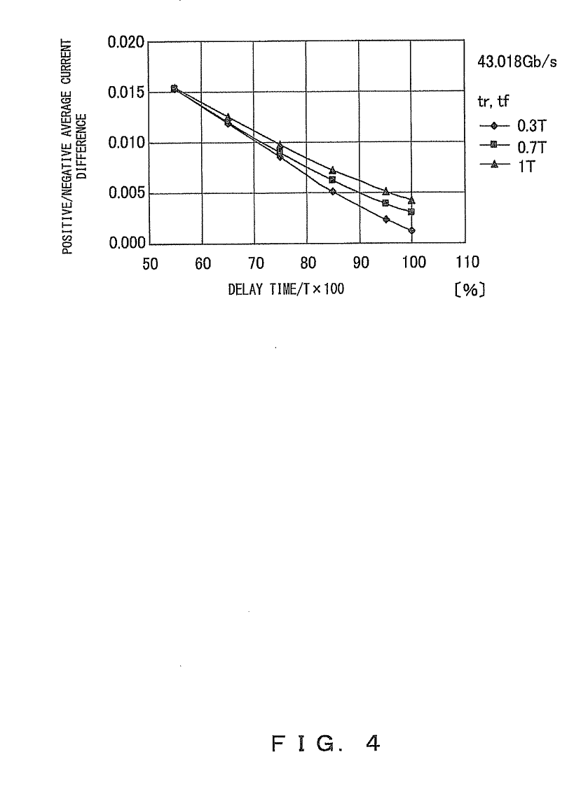

FIG. 4 shows a relationship between the positive-phase/negative-phase average light receiving current difference in the case where the phase error are 0 deg. and 15 deg. and the relative delay time to the period for one symbol T, and the dependency on rise-up time and fall-down time of a modulated signal waveform. The vertical axis of FIG. 4 indicates differential current between positive-phase/negative-phase average light receiving current and its horizontal axis indicates the percent of the delay time of the demodulator 31 for the period for one symbol T.

In FIG. 4, a point shown by a triangle indicates positive-phase/negative-phase average light receiving current difference in the case where the rise-up time tr/fall-down time tf of the waveform of a DPSK-modulated optical signal are the period for one symbol T in the transmission rate. A point shown by a rectangle indicates positive-phase/negative-phase average current difference in the case where the rise-up time tr/fall-down time tf of the waveform of a DPSK-modulated optical signal are 70% of the period for one symbol T. A point shown by a rhombus indicates positive-phase/negative-phase average current difference in the case where the rise-up time tr/fall-down time tf of the waveform of a DPSK-modulated optical signal are 30% of the period for one symbol T.

It is clearly found from FIG. 4 that the larger the rise-up time tr/fall-down time tf of the waveform of a DPSK-modulated optical signal is, the bigger the difference between positive-phase/negative-phase average light receiving current. It is also clearly found from FIG. 4 that the shorter the delay time of the demodulator 31 is, the bigger the difference between positive-phase/negative-phase average light receiving current. This characteristic can also apply to positive-phase average light receiving current and negative-phase average light receiving current.

It is because if the delay time of the demodulator 31 is reduced, it functions in such a way that in the positive phase a waveform in the transition area (rise-up/fall-down areas) may become close to the maximum value of its amplitude and in the negative phase it may lean to a 0 level, and the difference between the average of the waveform in positive phase and that in negative phase.

It is because if the rise-up/fall-down time of a waveform is larger, the time of the transition area being a factor for changing the average value increases and the change of the average value (average light receiving current) caused by a phase error increases that there is a correlation between the rise-up/fall-down time of the waveform of a phase-modulated optical signal and the average current difference.

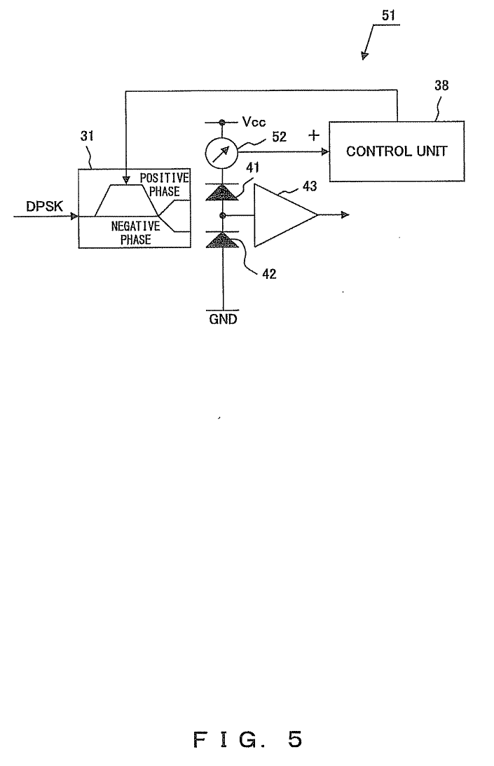

Next, FIG. 5 shows the phase adjustment circuit in the first preferred embodiment.

This first preferred embodiment controls the amount of delay of the demodulator 31 in such a way as to maximize the positive-phase average current flowing through the photoelectric conversion device 41.

A phase adjustment circuit 51 comprises a monitor circuit 52 for monitoring current flowing through the photoelectric conversion device 41, photoelectric conversion devices 41 and 42, an amplifier 43 and a control unit 38 for controlling the current of the phase adjustment heaters 35 and 36 of the demodulator 31.

The monitor circuit 52 detects positive-phase average current supplied to the photoelectric conversion device 41 from the power supply Vcc and outputs the detected current value to the control unit 38. The control unit 38 controls current to be supplied to the phase adjustment heaters 35 and 36 in such a way as to maximize positive-phase average current flowing through the photoelectric conversion device 41. Thus, the amount of delay of the demodulator 31, that is, the relative phase difference between the phase reference signal and the phase-modulated optical signal can be adjusted.

According to this first preferred embodiment, the phase error of a phase-modulated signal of the demodulator 31 can be reduced by adjusting the amount of delay of the demodulator 31 in such a way as to maximize the positive-phase average current flowing the photoelectric conversion device 41. Furthermore, since the photoelectric conversion devices 41 and 42 can be connected to the amplifier 43 in a short distance, the degradation of the signal quality due to the reflection of the RF component can be reduced.

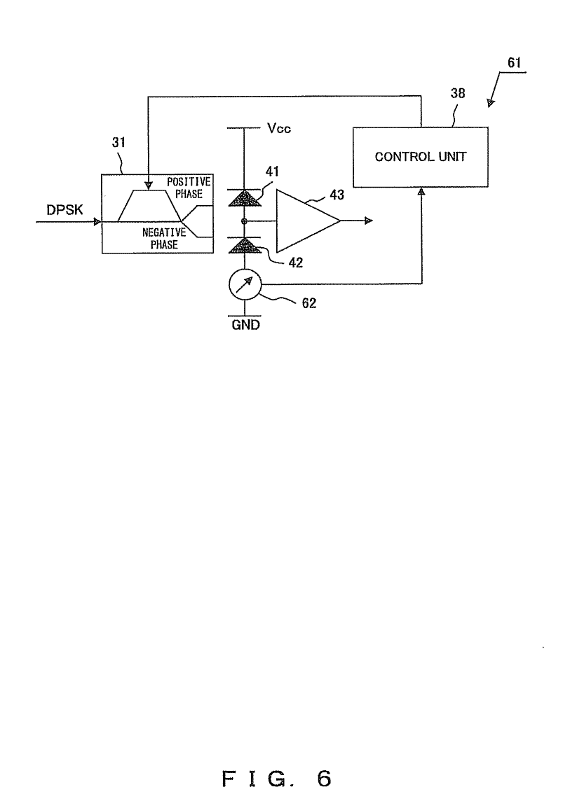

FIG. 6 shows the phase adjustment circuit 61 in the second preferred embodiment. This second preferred embodiment controls the amount of delay of the demodulator 31 in such a way as to minimize negative-phase average current flowing through the photoelectric conversion device 42.

A phase adjustment circuit 61 comprises a monitor circuit 62 for monitoring current flowing through the photoelectric conversion device 42, photoelectric conversion devices 41 and 42, an amplifier 43 and a control unit 38.

The monitor circuit 62 detects negative-phase average current which flows through the photoelectric conversion device 42, and outputs the detected current value to the control unit 38.

The control unit 38 controls current to be supplied to the phase adjustment heaters 35 and 36 in such a way as to minimize negative-phase average current flowing through the photoelectric conversion device 42.

According to this second preferred embodiment, the phase error of a phase-modulated signal of the demodulator 31 can be reduced by adjusting the amount of delay of the demodulator 31 in such a way as to minimize the negative-phase average current flowing the photoelectric conversion device 42. Furthermore, since the photoelectric conversion devices 41 and 42 can be connected to the amplifier 43 in a short distance, the degradation of the signal quality due to the reflection of the RF component can be reduced.

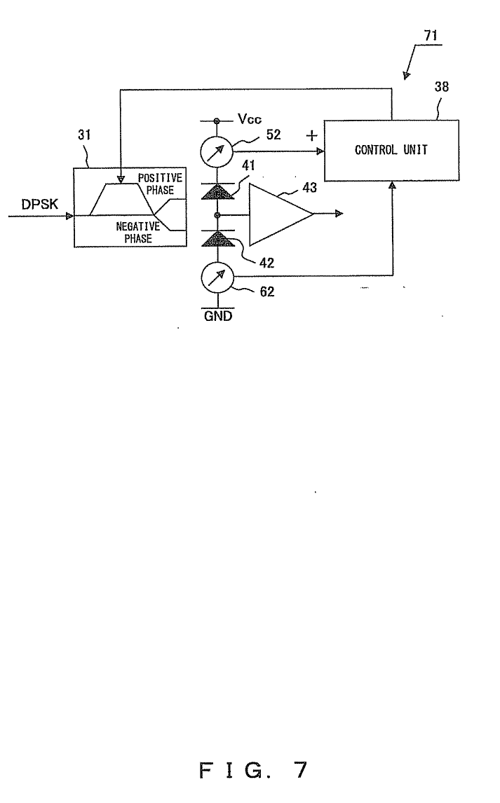

FIG. 7 shows the phase adjustment circuit in the third preferred embodiment. This third preferred embodiment controls the amount of delay of the demodulator 31 in such a way as to maximize the difference between the positive-phase average current flowing through the photoelectric conversion device 41 and the negative-phase average current flowing through the photoelectric conversion device 42.

A phase adjustment circuit 71 comprises a monitor circuit 52 and 62, photoelectric conversion devices 41 and 42, an amplifier 43 and a control unit 38.

The monitor circuit 52 detects positive-phase average current supplied to the photoelectric conversion device 41 from the power supply Vcc and outputs the detected current value to the control unit 38. The monitor circuit 62 detects negative-phase average current which flows through the photoelectric conversion device 42, and outputs the detected current value to the control unit 38.

The control unit 38 calculates the difference between the positive-phase average current value and the negative-phase average current value and controls current to be supplied to the phase adjustment heaters 35 and 36 in such a way as to maximize the difference between both.

According to this third preferred embodiment, the phase error of a phase-modulated signal of the demodulator 31 can be reduced by adjusting the amount of delay of the demodulator 31 in such a way as to maximize the difference between the positive-phase average current and the negative-phase average current. In the first to third preferred embodiments, since the photoelectric conversion devices 41 and 42 can be connected to the amplifier 43 in a short distance, the degradation of the signal quality due to the reflection of the RF component can be reduced.

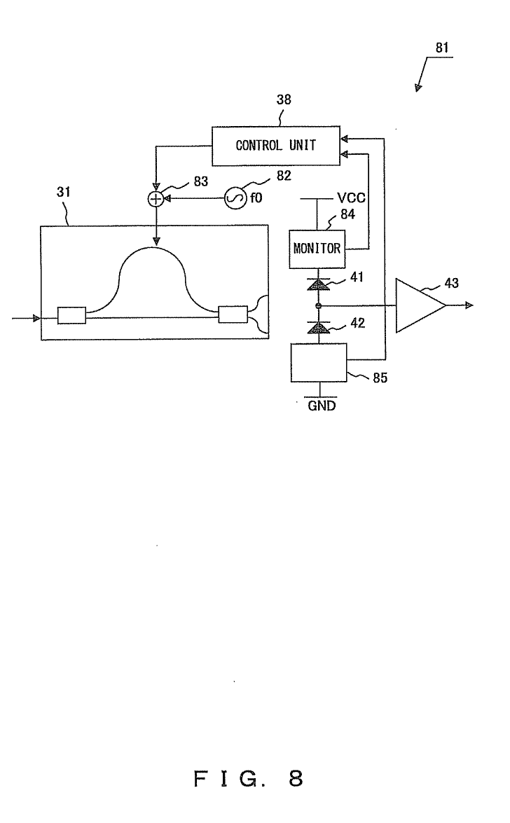

Next, FIG. 8 shows the phase adjustment circuit 81 in the fourth preferred embodiment. This fourth preferred embodiment superimposes a signal of a low frequency f0 on a signal for controlling the amount of delay (dithering) and controls the amount of delay in such away as to maximize or minimize the frequency component of a frequency f0 or 2f0 of average current.

A phase adjustment circuit 81 comprises monitor circuits 84 and 85, photoelectric conversion devices 41 and 42, an amplifier 43, a control unit 38, an oscillator 82 for generating signals of low frequencies f0 and an adder 83 for superimposing signal of a low frequency f0 on a control signal.

The adder 83 adds a signal of a low frequency f0 to a control signal outputted from the control unit 38 and supplies the control signal to the phase adjustment heaters 35 and 36 of the demodulator 31. The heater current of the phase adjustment heaters 35 and 36 is variably controlled by the control signal on which this signal of a low frequency f0 is superimposed and the amount of delay of the demodulator 31 is controlled by it.

The monitor circuit 84 comprises a narrow-band filter for extracting the frequency component of a frequency f0 or 2f0 of current flowing through the photoelectric conversion device 41 and outputs the current value of the extracted frequency component of a frequency f0 or 2f0 to the control unit 38.

The monitor circuit 85 comprises a narrow-band filter for extracting the frequency component of a frequency f0 or 2f0) of current flowing through the photoelectric conversion device 42 and outputs the current value of the extracted frequency component of a frequency f0 or 2f0 to the control unit 38.

The control unit 38 calculates the difference between the positive-phase/negative-phase average current values of a frequency component of a frequency f0 or 2f0 detected by the monitor circuits 84 and 85 and controls a control signal (a signal for variably controlling the current of the phase adjustment heaters 35 and 36) in such a way as to maximize or minimize the difference between them.

According to this fourth preferred embodiment, the phase error of a phase-modulated optical signal can be reduced by controlling the amount of delay of the demodulation 31 in such a way as to maximize or minimize the f0 or 2f0 component. Since the photoelectric conversion devices 41 and 42 can be connected to the amplifier 43 in a short distance, the degradation of the signal quality due to the reflection of the RF component can also be reduced. Furthermore, since the narrow-band filters of the monitor circuits 84 and 85 extract a component of a frequency f0 or 2f0 and cuts off signals of other frequencies, the noise can be reduced.

Alternatively, the control direction, specifically, which to control it in the direction for increasing or reducing the average current can also be determined the component of a frequency f0 of average current can be extracted, for example, the waveform of a component of a frequency f0 and the waveform of a signal of a frequency f0 are compared. Alternatively, its inclination can be calculated on the basis of the value of the component of a frequency f0 and it can be determined whether the heater current changes in the increasing or decreasing direction.

Although two monitor circuits 84 and 85 are used in the above-described fourth preferred embodiment, only one of the monitor circuits 84 and 85 can also ne used as in FIG. 5 or 6.

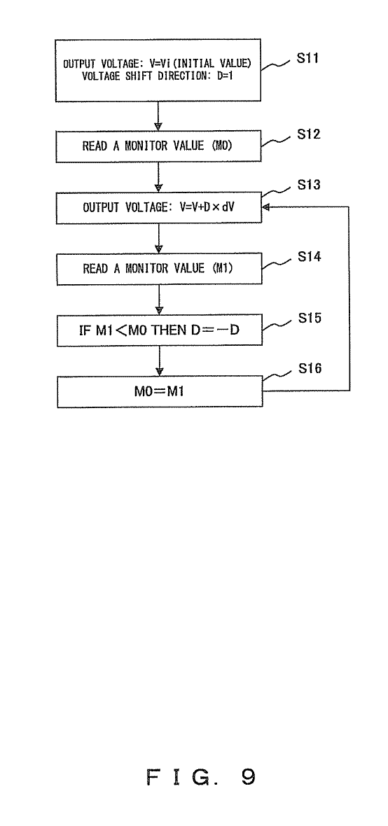

FIG. 9 is a flowchart showing the processing operation of the control unit 38 in the case where positive-phase average light receiving current, the difference between positive-phase/negative-phase average light receiving current or the component of a frequency 2f0 of average light receiving current after superimposing a signal of a frequency f0 on a control signal is monitored.

The control unit 38 sets Vi as the initial value of the output voltage V and sets “1” for specifying an increasing direction as direction data D for specifying the shift direction of the voltage (S11 in FIG. 9). In this example, the control unit 38 variably controls the output voltage V in order to variably control the current of the phase adjustment heaters 35 and 36.

Then, the monitor value M0 of a monitor circuit (for example, the monitor circuit 52 in FIG. 5) for monitoring positive-phase average light receiving current in the case of the output voltage V=Vi (S12).

Then, the output voltage V is calculated by adding D*dV to the voltage V (S13). The process in step S13 is used to increase or reduce the output voltage by adding the current value of the output voltage V a certain positive or negative value dV.

Then, the monitor value M1 of the increased or reduced output voltage V is read (S14).

Then, it is determined whether the current monitor M1 is smaller than the previous monitor value M0 (M1<M0). If M1<M0, the direction data D indicating the voltage shift direction is modified to “−D” (S15). Specifically, if is determined that the current monitor M1 is smaller than the previous monitor value M0, it is determined that it goes through the maximum value and the shift direction of the voltage is switched to the direction opposite till then. Thus, if it is controlled in the increasing direction of the output voltage, the control direction is switched to the reducing direction of the output voltage. If it is controlled in the reducing direction of the output voltage, the control direction is switched to the increasing direction of the output voltage.

If it is determined in step S15 that M1≧M0 or after the direction data D is modified when M1<M0, the process proceeds to step S16. In step S16, since the monitor value M1 is used as a previous value when monitoring it next time, it is stored as a monitor value M0.

The above-described process can also be applied when calculating the difference between positive-phase/negative-phase average light receiving current and controlling the amount of delay in such a way as to maximize the difference. Similarly it can also be applied when superimposing a signal of a low frequency of a frequency f0 on a control signal for controlling the amount of delay, extracting a component of a frequency 2f0 from the average light receiving current of a photoelectric conversion device and controlling the amount of delay.

According to the above-described process, the phase error of a phase-modulated signal can be reduced by controlling the amount of delay of the demodulator 31 in such a way as to put positive-phase average light receiving current close to the maximum value. Similarly, the phase error of a phase-modulated signal can be reduced by controlling the amount of delay of the demodulator 31 in such a way as to put the difference between positive-phase/negative-phase average light receiving current close to the maximum value. The phase error of the phase-modulated signal can be reduced by controlling the amount of delay of the demodulator 31 in such a way as to put the component of the frequency 2f of average light receiving current, on which a signal of a frequency f0 is superimposed close to the maximum value.

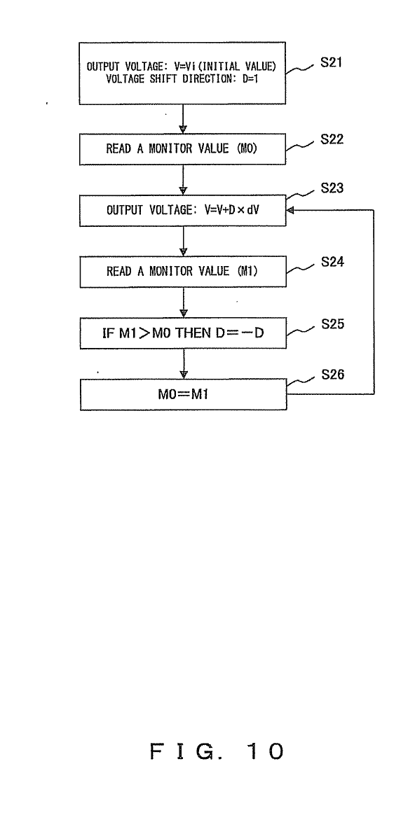

Next, FIG. 10 is a flowchart showing the processing operation of the control unit 38 in the case of monitoring negative-phase average light receiving current or monitoring a component of a frequency f0 of average light receiving current after superimposing a signal of a frequency f0 on a control signal.

The control unit 38 sets Vi as the initial value of the output voltage V and sets “1” for specifying an increasing direction as direction data D for specifying the shift direction of the voltage (S21 in FIG. 10). In this example, the control unit 38 variably controls the output voltage V in order to variably control the current of the phase adjustment heaters 35 and 36.

Next, the control unit 38 reads the monitor value M0 of the monitor circuit (for example, the monitor circuit 85 in FIG. 8) for monitoring negative-phase average light receiving current in the case of the output voltage V=Vi (S22).

Then, the output voltage V is calculated by adding D*dV to the voltage V (S23). The process in step S23 is used to increase or reduce the output voltage by adding the current value of the output voltage V a value obtained by multiplying a certain value dV by the direction data D.

Next, the monitor value M1 for the update output voltage V is read (S24).

Then, it is determined whether the current monitor M1 is larger than the previous monitor value M0. If M1≧M0, the direction data D indicating the voltage shift direction is modified to “−D”. Specifically, if is determined that the current monitor M1 is larger than the previous monitor value M0, it is determined that it goes through the minimum value and the shift direction of the voltage is switched to the direction that is opposite to the current direction. Thus, if it is controlled in the increasing direction of the output voltage, the control direction is switched to the reducing direction of the output voltage.

If it is determined in step S25 that M1<M0 or after the direction data D is modified when M1>M0, the process proceeds to step S26. In step S26, since the monitor value M1 is used as a previous value when monitoring it next time, it is stored as a monitor value M0.

The above-described process can also be applied when superimposing a signal of a low frequency of a frequency f0 on a control signal for controlling the amount of delay, extracting a component of a frequency f0 from the average light receiving current of a photoelectric conversion device and controlling the amount of delay.

According to the above-described process, the phase error of a phase-modulated signal can be reduced by controlling the amount of delay of the demodulator 31 in such a way as to minimize negative-phase average light receiving current. Similarly, the phase error of a phase-modulated signal can be reduced by controlling the delay by the control signal on which a signal of a frequency f0 and the amount of delay of the demodulator 31 in such a way as to minimize a component of a frequency f0 of average light receiving current.

According to the disclosed phase-modulated signal receiving device, a small-size phase-modulated signal receiving device the degradation of whose receiving sensitivity is small can be realized.

According to this phase-modulated signal receiving device, since it is not necessary to branch a main signal and monitor it, its receiving sensitivity can be prevented from degrading. Furthermore, since in order to monitor an optical signal, there is no need of another photoelectric conversion device separately from the main signal system, a structure for obtaining a monitor signal can also be miniaturized. Accordingly, the receiving device can be miniaturized.

The application of the present invention is limited to the delay interferometer and the present invention can be applied to any interferometer as long as it controls the phase of a phase reference light by controlling the amount of delay. A method for variably controlling the amount of delay is not limited to the method using a phase adjustment heater and another optical delay device can also be used.

What is claimed is:

1. A phase-modulated signal receiving device, comprising:
an interferometer for making a phase-modulated optical signal interfere with a phase reference light obtained by delaying the phase-modulated optical signal and outputting an intensity-modulated optical signal according to a phase difference with the optical signal;
a photoelectric conversion device for converting the intensity-modulated optical signal outputted from the interferometer to an electric signal;
a monitor unit for detecting the DC component or a sufficiently lower frequency component than a phase-modulated frequency of current flowing through the photoelectric conversion device; and
a control unit for controlling amount of delay of the phase reference light of the interferometer in such a way as to maximize or minimize average current detected by the monitor unit.

2. The phase-modulated signal receiving device according to claim 1, wherein
one of photoelectric conversion devices receives the positive-phase intensity-modulated optical signal outputted from the interferometer,
the monitor circuit monitors positive-phase average light receiving current of the photoelectric conversion device and
the control unit controls amount of delay of the interferometer in such a way as to maximize the positive-phase average light receiving current monitored by the monitor unit.

3. The phase-modulated signal receiving device according to claim 1, wherein
one of photoelectric conversion devices receives the negative-phase intensity-modulated optical signal outputted from the interferometer,
the monitor circuit monitors negative-phase average light receiving current of the photoelectric conversion device and
the control unit controls amount of delay of the interferometer in such a way as to minimize the negative-phase average light receiving current monitored by the monitor unit.

4. The phase-modulated signal receiving device according to claim 1, wherein
the photoelectric conversion device comprises a first photoelectric conversion device for receiving a positive-phase intensity-modulated optical signal outputted from the interferometer and a second photoelectric conversion device for receiving a negative-phase intensity-modulated optical signal outputted from the interferometer,
the monitor unit comprises a first monitor unit for monitoring average light receiving current of the first photoelectric conversion device and a second monitor unit for monitoring average light receiving current of the second photoelectric conversion device, and
the control unit controls amount of delay of the interferometer in such a way as to maximize a difference between positive-phase average light receiving current monitored by the first monitor unit and negative-phase average light receiving current monitored by the second monitor unit.

5. The phase-modulated signal receiving device according to claim 1, further comprising
a superimposition unit for superimposing a low frequency signal of a frequency f on a control signal for controlling the amount of delay of the interferometer, outputted from the control unit, wherein
the control unit the amount of delay of the interferometer in such a way as to maximize a frequency component of a frequency 2f of average light receiving current of the photoelectric conversion device.

6. The phase-modulated signal receiving device according to claim 1, further comprising
a superimposition unit for superimposing a low frequency signal of a frequency f on a control signal for controlling the amount of delay of the interferometer, outputted from the control unit, wherein
the control unit the amount of delay of the interferometer in such a way as to minimize a frequency component of a frequency f of average light receiving current of the photoelectric conversion device.

7. The phase-modulated signal receiving device according to claim 1, wherein
the interferometer comprises a positive-phase output port and a negative-phase output port which output complementary optical signals,
the photoelectric conversion device comprises a first photoelectric conversion device for receiving an output signal of the positive phase output port and a second photoelectric conversion device for receiving an output signal of the negative phase output port and
the monitor unit monitors a DC component or a low frequency component of current flowing through one of the first and second photoelectric conversion devices.

8. The phase-modulated signal receiving device according to claim 1, wherein
the optical signal inputted to the interferometer is a differential phase shift keying (DPSK)-modulated optical signal and
the interferometer branches the optical signal into two, makes one of the branched optical signals delay by approximately one symbol and specifies it as the phase reference light, and makes the phase reference light interfere with the other of the branched optical signals.

9. The phase-modulated signal receiving device according to claim 1, wherein
the interferometer branches the optical signal into two, makes one of the branched optical signals delay by time less than one symbol.
